(19) United States
(12) Patent Application Publication
(10) Pub. No.: US 2003/0104234 A1
(43) Pub. Date: Jun. 5, 2003

(54) Polyester carbonate and a data carrier therefrom

(76) Inventors: Friedrich-Karl Bruder, Krefeld (DE); Wilfried Haese, Odenthal (DE); Rolf Wehrmann, Krefeld (DE); Peter Fischer, Koln (DE); Marco Roelofs, Krefeld (DE); Silke Kratschmer, Krefeld (DE)

Correspondence Address: BAYER CORPORATION, PATENT DEPARTMENT, 100 BAYER ROAD, PITTSBURGH, PA, 15205, US

(21) Appl. No.: 10/239,034

(22) PCT Filed: Mar. 12, 2001
(86) PCT No.: PCT/EP01/02728

(30) Foreign Application Priority Data
Mar. 23, 2000 (DE) 100 14 372.5
Sep. 15, 2000 (DE) 100 45 587.5

(51) Int. Cl. C08K 5/10

(52) U.S. Cl. 428/480; 524/51; 524/306

(57) ABSTRACT

A copolyester carbonate especially suitable for the preparation of machine readable data carriers is disclosed. The inventive copolyester carbonate contains structural units derived from acids according to formula (I),

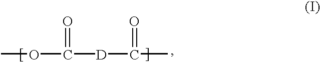

wherein

D denotes a mixture of divalent hydrocarbon radicals substantially corresponds to one or more of

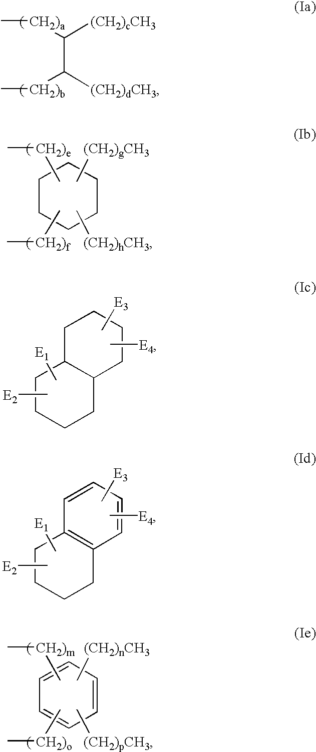

wherein E₁, E₂, E₃ and E₄ denote one of the substituents —(CH₂)ᵢ—, —(CH₂)ⱼ—, —(CH₂)ₖCH₃ and —(CH₂)₁CH₃, and a, b, c, d, e, f, g, h, i, j, k, l, m, n, o and p independently of one another denote an integer between 1 and 10.

The present invention relates to new polyester carbonates, machine-readable data carriers containing the latter and further moulded parts containing the latter. Polycarbonate is preferably used in machine-readable data carriers such as compact discs. For this application it is important that the materials have a high transparency, low affinity for water, good heat resistance and low double refraction. The increase in the data density will improve well established and new storage technologies such as CD-ROM (read only), CD-R (recordable), CD-RW (rewriteable), DVD (digital versatile disk) and MO-disks (magnetoopitcal) and will also place more stringent demands on the substrate materials.

In the formats described above, such as CD-ROM, the information is impressed in the form of so-called pits directly into a transparent thermoplastic material such as bisphenol A (BPA) polycarbonate. The surface is then coated with a reflective metallic film and the digital information, which is coded by means of the length and position of the pits, is optically read by a low output (ca. 0.5mW) focused laser beam. The stored information can subsequently no longer be changed in this case (read-only format).

The mode of operation of a one-time writeable format such as CD-R consists in writing permanent markings with a focused laser beam (up to 40 mW) on a thin film applied to a disc. The changes in the optical properties thereby generated (absorption, reflectivity) can be detected with a reading laser. Since reversible processes take place the information can be stored only once and cannot then be overwritten (WORM principle, write once, read many).

Multiply writeable media are particularly important for the computer industry. Two systems are currently widely used: magnetooptical (MO) systems and phase change (PC) systems. In MO storage a bit is stored as roughly 1 μm size magnetic domain with either up or down magnetisation on an evaporation coated layer (of, inter alia, amorphous alloys of rare earth metals and transition metals). The magnetisation states are maintained by heating above the Curie temperature T_{c} followed by cooling in a variable magnetic field. The information stored in this way is optically read by the rotation of the plane of polarisation of the light in the magnetic thin layer. This so-called magnetooptical Kerr effect typically leads to a rotation of the polarisation of less than 0.5°. Double refracting substrate materials similarly lead to a particularly interfering change in polarisation of the light in this case. For this reason substrate materials with a low double refraction are particularly important in MO systems.

With phase change materials the information is stored in regions having different phases—typically amorphous or crystalline. Alloys or compounds of tellurium in which the glass transition temperature is close to the crystallisation temperature are generally used as information layer. The film can be converted locally from a crystalline state to an amorphous state by heating above the melting point using a brief focused laser pulse and rapid cooling. Compared to the crystalline state the reflectivity is changed, which can be detected optically with a laser.

In addition to this narrow tolerances apply to the geometry of the optical beam path for the writing and reading process. Changes in the ambient conditions, such as temperature and atmospheric moisture, can distort the disc, which has an adverse effect on the writing and reading process. The water uptake by the substrate materials causes swelling and thus an increase in volume, which is manifested in a bending of the disc, particularly in the case of unsymmetrically constructed storage formats. A low water uptake by the polymer is thus a further important property that has to be realised.

In the course of recent developments in optical data carriers the demands on the carrier material have become increasingly stringent and require the purposeful development of new materials, for example with the object of achieving a lower double refraction and reduced water uptake, in particular for the shorter writing and reading wavelengths to be expected in the future, which impose new requirements.

Low double refraction and reduced water uptake are however not the only important properties for the substrate materials of optical data carriers, which must in addition exhibit the best possible combination of further properties such as high transparency, heat resistance, flowability, toughness, high purity, low density, low levels of inhomogeneities or particulate matter, as well as, above all, low raw material and manufacturing costs.

The materials currently proposed for these applications fail in one or more of these requirements and there is therefore a need for new materials for higher storage density.

Polyester carbonates consisting of linear or cyclic difunctional aliphatic carboxylic acids, bisphenols and carbonate precursors are described for example in EP 433 716 A, U.S. Pat. Nos. 4,983,706 and 5,274,068, which also describe various processes for their synthesis. The person skilled in the art knows that the incorporation of dicarboxylic acids leads to a reduction in the glass transition temperature and an increase in the flowability. For use as substrate materials however the reduction in the glass transition temperature restricts the usability of the discs since their heat resistance is thereby reduced. In addition these products, on account of the polar ester groups, have a water uptake that is unacceptably high for use in optical data storage media. As is disclosed in EP 433 716 A, the known carboxylic acids for polyester carbonates can only be incorporated in significant amounts in the phase boundary process by a complicated, expensive and multi-stage procedure.

Furthermore polyester carbonates, in particular those formed from linear and relatively long-chain dicarboxylic acids, have an undesirable tendency to undergo crystallisation, which interferes particularly in the very slow cooling that may be necessary to produce very fine structures and reduce the process-dependent double refraction.

Dimeric fatty acids as possible acid building blocks in polyester carbonates are listed for example in DE 43 06 961 A, U.S. Pat. No. 5,134,220 and EP 443 058 A. A more precise definition of the acids to be used is not given. In the case of non-hydrogenated dimeric fatty acids however thermooxidative problems arise. In addition the commercially available products contain more than 3 mole % of tribasic and polybasic carboxylic acids, leading to a high zero shear viscosity that is undesirable in the formation of microstructures such as pits or grooves. For this reason these polyester carbonates have hitherto generally been regarded as unsuitable for use as substrates of optical data storage media.

The object of the invention is to provide machine-readable data carriers for increased data densities that do not exhibit the aforementioned disadvantages, that have in particular improved optical properties, and that can be produced simply and efficiently.

This object is achieved by data carriers containing a resin comprising polyester carbonates with repeating, bifunctional structural units A according to formula (I),

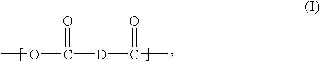

wherein

D denotes a mixture of divalent hydrocarbon radicals that contain 30 to 42 carbon atoms, preferably 32 to 38 and particularly preferably 34 carbon atoms. D corresponds substantially to formula Ia and/or Ib and/or Ic and/or Id and/or Ie.

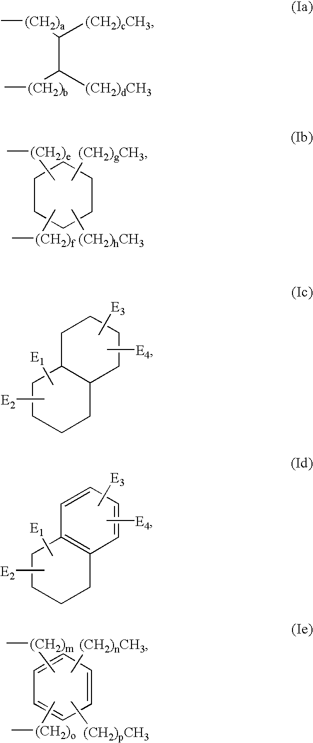

wherein E₁, E₂, E₃ and E₄ in formulae Ic and Id in each case denote one of the substituents —(CH₂)ᵢ—, —(CH₂)ⱼ—, —(CH₂)ₖCH₃ and —(CH₂)₁CH₃, and a, b, c, d, e, f, g, h, i, j, k, l, m, n, o and p independently of one another denote an integer between 1 and 10.

It has been found that substrates comprising polyester carbonates according to the invention with repeating, bifunctional structural units derived from aromatic bisphenols and hydrogenated dimeric fatty acids containing a high proportion of difinctional acids, are characterised by a surprisingly particularly low water uptake, extremely low double refraction, very low tendency to crystallisation, low refractive index, good flowability, and low density.

The high glass transition temperature of homopolycarbonates of certain bisphenols such as 1,1-bis-(4-hydroxyphenyl)-3,3,5-trimethylcyclohexane or 6,6′-dihydroxy-3,3,3′,3′-tetramethyl-1,1′-spiro(bis)-indane can be efficiently reduced to a level that is acceptable for flowability and heat resistance in optical data carriers by co-condensation with very small molar proportions of the acids to be used according to the invention.

The substrates for data carriers produced from the new polyester carbonates also have a high transparency, good mechanical properties, especially at low temperatures, and high flowability.

Hydrogenated dimeric fatty acids in connection with the present invention are acids that may be obtained by dimerisation of unsaturated monobasic fatty acids with 16 to 22 carbon atoms, followed by hydrogenation. The necessary acids may be obtained for example from plant or animal sources. The synthesis and properties are described for example in Encyclopaedia of Chemical Technology, Vol. 8, 4^{th} ed., John Wiley&Sons: 1993, pp. 223-237.

Apart from the structural elements mentioned in formula I the dimeric fatty acids may contain small proportions of unsaturated aliphatic groups. Dimeric fatty acids with an iodine number of less than 15 are preferred.

In addition the dimeric fatty acids may contain a small amount of monobasic and polybasic fatty acids. Products with very small proportions of these components, in particular with small proportions of tribasic and polybasic acids, are especially suitable for producing the polyester carbonates according to the invention. Dimeric fatty acids with a proportion of tribasic and polybasic acids of less than 1.5%, determined by gas chromatography, are therefore preferred. The invention also covers mixtures of dimeric fatty acids with other difimctional carboxylic acids having 4 to 40 carbon atoms, such as adipic acid, sebacic acid, α,ω-dodecanoic dicarboxylic acid, terephthalic acid, cis- or trans-9-octadecen-α,ω-dicarboxylic acid, or hydroxycarboxylic acids with 4 to 40 carbon atoms such as salicylic acid or p-hydroxybenzoic acid.

The dimeric fatty alcohols obtained from dimeric fatty acids by reduction may also be used within the scope of the invention and converted to polycarbonates, or mixtures or esters of dimeric fatty alcohols with dimeric fatty acids may be converted to polyester carbonates.

Preferably at least one of the further bifunctional structural units, different from A, of the formula (II) is used as bifunctional structural unit B

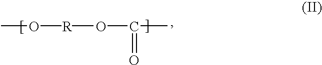

wherein the radical —O—R—O— denotes arbitrary diphenolate radicals in which —R— is an aromatic radical with 6 to 40 C atoms that may contain one or more aromatic or condensed aromatic nuclei optionally containing heteroatoms and is optionally substituted with C₁-C₁₂-alkyl radicals or halogen, and may contain aliphatic radicals, cycloaliphatic radicals, aromatic nuclei or heteroatoms as bridge members.

The bifunctional structural units B are particularly preferably derived from diphenol compounds of the formulae (IIIa) to (IIIc)

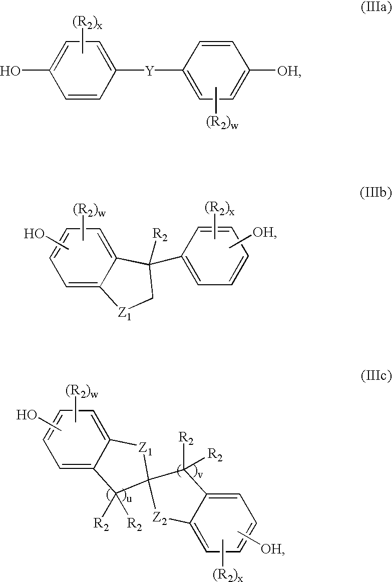

in which

Z₁ and Z₂ independently of one another in each case denote a divalent radical —C(R₂R₂)—, —O—, —S—, —N(R₂)—, —N—((R₂)C(═O)—,

R² independently of one another in each case denote a C₁ to C₁₂ alkyl radical, preferably C₁ to C₃-alkyl radical, particularly preferably methyl, a C₆ to C₁₉-aryl radical, preferably phenyl radical, a C₇ to C₁₂-aralkyl radical, preferably phenyl-C₁ to C₄-alkyl, particularly preferably benzyl radical, hydrogen, halogen, preferably chlorine or bromine,

U and V independently of one another denote an integer from 0 to 3, preferably 1 and 2,

W and X independently of one another denote an integer from 0 to 3, preferably 0, and

Y denotes a single bond, a C₁ to C₆-alkylene radical, C₂ to C₅-alkylidene radical, C₅ to C₆-cycloalkylidene radical that may be substituted with C₁ to C₆-alkyl, preferably methyl or ethyl radicals, or a C₆ to C₁₂-arylene radical that may optionally be condensed with further aromatic rings containing heteroatoms.

Examples of these diphenols of the formula (IIIa), (IIIb) and (IIIc) that may be mentioned include 4,4′-dihydroxydiphenyl, 2,2-bis-(4-hydroxyphenyl)-propane, 2,4-bis-(4-hydroxy-phenyl)-2-methylbutane, 2,2-bis-(3-methyl-4-hydroxyphenyl)-propane, 1,1-bis-(3-methyl-4-hydroxyphenyl)-cyclohexane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, 2,4-bis-(3,5-dimethyl-4-hydroxyphenyl-2-methylbutane, 2,2,-bis-(3,5-dichloro-4-hydroxyphenyl)-propane, 2,2-bis-(3,5-dibromo-4-hydroxyphenyl)-propane, 1,1-bis-(4-hydroxyphenyl)-3,3,5-trimethylcyclohexane and 1,1-bis-(4-hydroxyphenyl)-cyclohexane, 6,6′-dihydroxy-3,3,3′,3′-tetramethyl-1,1′-spiro-(bis)-indane, 1-(p-hydroxyphenyl)-1,3,3-trimethyl-5-indanol and 9,9-bis-(4-hydroxyphenyl)-fluorene. Preferred diphenols of the formulae (IIIa), (IIIb) and (IIIc) are 2,2-bis-(4-hydroxyphenyl)-propane, 2,2-bis-(3,5-dimethyl-4-hydroxyphenyl)-propane, 1,1-bis-(4-hydroxyphenyl)-cyclohexane, 1,1-bis-(4-hydroxyphenyl)3,3,5-trimethylcyclohexane, 6,6′-dihydroxy-3,3,3′,3′-tetramethyl-1,1′-spiro(bis)-indane, 9,9-bis-(4-hydroxyphenyl)fluorene, 1,1-bis-(3-methyl-4-hydroxyphenyl)-cyclohexane, 1-(p-hydroxyphenyl)-1,3,3-trimethyl-5-indanol and 4,4′(m-phenylenediisopropylidene)-diphenol.

The diphenols may be used individually or as a mixture of several diphenols for producing the substrates according to the invention.

The carbonate structural units of the formula (II) are particularly preferably derived from 1,1-bis-(4-hydroxyphenyl)-3,3,5-trimethylcyclohexane.

In addition bifunctional monophenols such as resorcinol, hydroquinone or their derivatives substituted singly or multiply by C₁ to C₁₂-alkyl, C₆ to C₁₉-aryl or C₇ to C₁₉-aralkyl may also be used for the production of the substrates according to the invention.

Preferred polyester carbonates according to the invention are those containing 0.5 to 49 mole %, preferably 2 to 40 mole %, particularly preferably 5 to 20 mole % of structural units A, referred to 100 mole % of the bifunctional structural units A and B.

The preparation of the substrates according to the invention may be carried out according to the three known methods (see H. Schnell “Chemistry and Physics of Polycarbonates”, Polymer review, Volume IX, page 27 ff; Interscience Publishers, New York 1964, as well as DE 1495 626 A, DE 22 32 877 A, DE 27 03 376 A, EP 274 544A, DE 30 00 610 A, DE 38 32 396 A).

1. According to the solution process in disperse phase known as the “two-phase boundary surface process”.

In this process the diphenols and bifunctional acids to be used are dissolved in aqueous alkaline phase. In addition the chain terminators required for the preparation of the polyester carbonates according to the invention are optionally dissolved in amounts of 1.0 to 20 mole %, referred to moles of diphenol plus acid according to the invention, in an aqueous alkaline phase, preferably caustic soda, or are added in bulk to the latter and an inert organic phase. The reaction is then carried out with phosgene in the presence of an inert, preferably polycarbonate-dissolving organic phase. The reaction temperature is between 0° C. and 50° C. The addition of the necessary chain terminators, branching agents and acids according to the invention may take place in bulk, as a melt, or as a solution in an alkali or inert organic solvents, also during the phosgenation or as long as chlorocarbonates are present in the synthesis mixture.

The reaction may be accelerated by catalysts such as tertiary amines or onium salts. Tributylamine, triethylamine and N-ethylpiperidine, as well as tetrabutyl ammonium, tetraethyl ammonium and N-ethylpiperidinium salts are preferred.

In addition to or instead of the diphenols, their chlorocarbonates and/or bischlorocarbonates may also be used or metered in during the synthesis. Instead of the dimeric fatty acids, their acid chlorides may also be used. Suitable solvents are for example methylene chloride, chlorobenzene, toluene and their mixtures.

2. According to the solution process in homogenous phase, also known as the “pyridine process”.

In this case the diphenols and acids according to the invention are dissolved in organic bases such as pyridine, optionally with the addition of further organic solvents, following which the chain terminators and branching agents required for the preparation of the polyester carbonates according to the invention are optionally added as described in 1.

Reaction with phosgene is then carried out. The reaction temperature is between 10° C. and 50° C. Suitable organic bases apart from pyridine are for example triethylamine, tributylamine, N-ethylpiperidine, as well as N,N-dialkyl-substituted anilines such as N,N-dimethylaniline. Suitable solvents are for example methylene chloride, chlorobenzene, toluene, tetrahydrofuran, 1,3-dioxolane and their mixtures.

In addition to the diphenols up to 50 mole %, referred to the phenols used, of their bischlorocarbonates may also be employed. The fatty acids according to the invention may be partially or wholly replaced by their acid chlorides. The addition of the necessary chain terminators, branching agents and acids according to the invention may take place in bulk, as a melt or as a solution in inert organic solvents also during the phosgenation or as long as chlorocarbonates are present in the synthesis mixture.

The polyester carbonates according to the invention are separated in a known manner in the processes 1. and 2. Suitable working-up processes are in particular precipitation, spray drying and evaporation of the solvent in vacuo.

3. According to the melt transesterification process

The molecular weight is increased in the melt transesterification process under the addition of diphenyl carbonate in stoichiometric amounts or in excess of up to 40%, to a diphenyl melt/fatty acids, with constant distillative removal of phenol and optionally diphenyl carbonate excess. This process is carried out as a one-stage or two-stage process, i.e. with the possible separate condensation of the oligomers and polymers, using conventional catalysts such as alkali metal ions, e.g. Li, Na, K, transition metal compounds, e.g. those based on Sn, Zn, Ti, or nitrogen bases or phosphorus bases, preferably ammonium salts and phosphonium salts, preferably phosphonium halides or phosphonium phenolates.

Instead of the acids to be used according to the invention, their aromatic or aliphatic esters, e.g. methyl, ethyl, isopropyl or phenyl esters, may be used.

Chain terminators and/or branching agents may be used in addition in a known manner for the preparation of the polyester carbonates according to the invention. The corresponding chain terminators and/or branching agents are known inter alia from EP 335 214 A and DE 30 07 934 A, or from EP 411 433 A, DE 43 35 440 A and EP 691 361 A. Also, the branching agents and/or chain terminators may be wholly or partially replaced by dimeric fatty acids containing a relatively high proportion of trifunctional and/or monofunctional carboxylic acids.

In addition the substrates formed from the polyester carbonates according to the invention may be mixed with various thermoplastic polymers in a weight ratio of 2:98 to 98:2 and used as blends.

The polyester carbonates according to the invention have mean molecular weights M_{w} (weight average molecular weight determined by gel chromatography after prior calibration using bisphenol A-PC) of at least 6,000, preferably between 7,000 and 40,000, particularly preferably between 9,000 and 30,000.

The following conventional additives for thermoplastic polycarbonates may be added in the conventional amounts to the substrates used for producing the data carriers according to the invention, before, during or after their processing; stabilisers, e.g. heat stabilisers such as organic phosphites, optionally in combination with monomeric or oligomeric epoxides; UV stabilisers, in particular those based on nitrogen-containing heterocyclic compounds, such as triazoles; optical brighteners, flame retardants, in particular fluorine-containing compounds such as perfluorinated salts of organic acids, polyperfluoroethylene, salts of organic sulfonic acids and their combinations; mould release agents; flow auxiliaries; fire retardants; colouring agents; pigments; antistatics; fillers and reinforcing substances, comminuted minerals, fibre substances, e.g. alkyl and aryl phospites, phosphates, phosphanes, low molecular weight carboxylic acid esters, halogen compounds, salts, chalk, quartzes, inorganic or organic nanoparticles, glass and carbon fibres.

The data carriers according to the invention or other moulded parts may be produced in a known manner by injection moulding or injection-compression moulding in known machines.

Polyester carbonates according to the invention containing structural units A and B, which are derived from 1,1-bis-(4-hydroxyphenyl)-3,3,5-trimethylcyclohexane and contain 0.5 to 49 mole %, preferably 2 to 40 mole %, particularly preferably 10 to 25 mole % of bifunctional ester structural units A, referred to 100 mole % of the bifunctional structural units A and B, are particularly suitable on account of their low rheooptical constant CR, but also on account of their very low yellowness index YI, for producing the data carriers according to the invention. The yellowness index is measured with a small, 4 mm thick injection moulded plate according to ASTM Standard E 313/96.

The substrates must have a high degree of purity, in particular for producing data carriers according to the invention. This is achieved by reducing in a known manner the contents of the residual monomers, solvents, foreign particles (of an inorganic or organic nature, in particular salts and dust) and chlorine to the lowest possible values during the working-up and separation of the substrate resin. This is described for example in EP 380 002 A or EP 691 361 A, to which reference should be made.

The data carriers according to the invention may be produced in various formats. Particularly preferred are known formats such as optical cards or cylindrical perforated discs as in compact discs (CD), CD-recordables (CD-R), digital versatile discs (DVD) or minidiscs (MD).

Information storage layers (e.g. phase change layers, magnetooptic layers, dyes, fluorescing dyes, photopolymers), dielectric (e.g. Si/N), reflecting (e.g. silver, gold or aluminium), semi-reflecting (e.g. Si, Ge), or protective layers (e.g. acrylic lacquers) and further functional layers may be applied to the substrate. Different sequences of such layers are possible.

Several layers of the substrate may be laminated with one another or layers may be laminated with other substrates. The stored information may be impressed into the substrate (e.g. as a pit structure) or deposited in separate information layers. The information may be read through the transparent substrate or from the information side.

Optical information storage media in which the substrate material according to the invention is used in the form of films, e.g. for covering the information layer in DVR (direct video recording) or as a substrate of multilayer systems (optionally with impressed information), are also the subject of the invention.

The invention also provides the described polyester carbonates and other moulded parts containing the latter, such as optical lenses, sheets and films that contain the polyester carbonates according to the invention, and the use of these polyester carbonates for producing such moulded parts. The outstanding properties of these polyester carbonates are utilised in particular in optical lenses.

The following examples serve to illustrate the invention further.

### EXAMPLES

Determination of the Rheooptical Constant C_{R}.

Double refraction in injection moulded parts, which is one of the most important optical properties, can be described as a material property through the rheooptical constant, which may be negative or positive. The greater the absolute value of the constant, the greater the double refraction in injection moulded parts. The process for measuring the rheooptical constant is known (EP 0 621 297 A). The plane parallel, 150 to 1000 μm thick test bodies required for this purpose may be produced by melt pressing or film casting.

The molecular weight is determined by measuring the relative viscosities at 25° C. in methylene chloride and at a concentration of 0.5 g per 100 ml of methylene chloride. The T_{g} determination was carried out according to Standard CEI/IEC 1074. The water uptake was determined according to DIN 53 495 (process 1+1 L). The density was measured according to the Archimedes principle (Mettler density measuring kit)

The hydrogenated dimeric fatty acid that is used (Pripol® 1009 from Uniqema) has the following specification: iodine <10, monomer content <0.1%, trimer content <1%.

### Example 1

The following polyester carbonate is prepared:

3036.2 g of sodium carbonate are dissolved in 12.2 kg of water and ca. 10 1 of methylene chloride while slowly stirring in a vessel provided with a stirrer. A solution of 1093.4 g of Pripolo 1009 in 27 1 of methylene chloride is then added and the whole is stirred for 5 minutes. 944.5 g of phosgene are introduced in ca. 30 minutes while stirring vigorously at temperatures below 15° C. and at a pH of 10 to 8. A solution of 4035.7 g of 1,1-bis-(4-hydroxyphenyl)-3,3,5-trimethylcyclohexane, 1248 g of sodium hydroxide and 25 1 of water is then pumped in within 15 minutes. A further 3214.8 g of phosgene are next introduced over 70-80 minutes, a pH of 11-12 being maintained by metering in 30% caustic soda solution. The reaction mixture is stirred for 5 minutes, followed by the addition of 58.6 g of 4-tert.-butylphenol. 18 ml of N-ethylpiperidine are added after a further 5 minutes and the whole is stirred for 30 minutes. Following this the phases are separated; the organic phase is then acidified with water and washed until neutral, and freed from solvent, extruded and granulated.

### Example 2

The following polyester carbonate is prepared:

2776.8 g of sodium carbonate are dissolved in 11.1 kg of water, 998.4 g of Pripol® 1009 and 33.9 1 of methylene chloride while slowly stirring in a vessel provided with a stirrer. 863.2 g of phosgene are introduced in ca. 30 minutes while stirring vigorously at temperatures below 15° C. and at a pH of 10 to 8. A solution of 2620.8 g of 1,1-bis-(4-hydroxyphenyl)-3,3,5-trimethylcyclohexane, 1040 g of 2,2-bis-(4-hydroxyphenyl)-propane, 1248 of sodium hydroxide and 22.7 1 of water is then pumped in within 15 minutes. A further 3214 g of phosgene are next introduced in ca. 90 minutes, a pH of 11-12 being maintained by metering in 30% caustic soda solution. The reaction mixture is stirred for 5 minutes, following which 79 g of 4-tert.-butylphenol are added. 18 ml of N-ethylpiperidine are added after a further 5 minutes and the whole is stirred for 45 minutes. Following this the phases are separated; the organic phase is then acidified and washed with water until neutral, and freed from solvent, extruded and granulated.

### Comparison Example

3104.4 g of 1,1-bis-(4-hydroxyphenyl)-3,3,5-trimethylcyclohexane are dissolved in 30.3 kg of water and 880 g of sodium hydroxide in a vessel provided with a stirrer. 22.8 1 of methylene chloride are then added. 1978.3 g of phosgene are introduced in ca. 40 minutes while stirring vigorously at temperatures of 15° C. to 25° C. and at a pH of 11 to 13. The pH is maintained at the above value by metering in 30% caustic soda solution. The reaction mixture is stirred for 5 minutes, following which 82.5 g of isooctylphenol are added. 20 ml of N-ethylpiperidine are added after a further 5 minutes and the whole is stirred for 45 minutes. Following this the phases are separated; the organic phase is then acidified and washed with water until neutral, and freed from solvent.

The polyester carbonates that are obtained and a standard CD material (Makrolon CD 2005) have the following properties shown in Table 1:

TABLE 1

| | | | | Glass | | | Water uptake | | | | |
|---|---|---|---|---|---|---|---|---|---|---|---|
| | Composition [mole %] | | | transition | Rheooptical | Relative | [wt. %] | | | | |
| | BP- | BP- | Pripol | temperature | constant | solution | After 24 | | Density | | Abbe |
| Example: | A | TMC | 1009 | [° C.] | [1/GPa] | viscosity | hrs: | Saturated | [gcm⁻³] | n²⁰_{D} | No. |
| 1 | 31 | 57 | 12 | 131 | 3.1 | 1.212 | 0.15 | 0.18 | 1.098 | 1.554 | 27.3 |
| 2 | 0 | 87 | 13 | 145 | 2.0 | 1.17 | 0.18 | 0.20 | 1.080 | 1.547 | 35.0 |
| Comparison | 0 | 100 | 0 | 239 | 2.7 | 1.18 | 0.33 | 0.38 | 1.100 | 1.550 | — |
| CD 2005 | 100 | 0 | 0 | 145 | 5.4 | 1.20 | 0.25 | 0.34 | 1.200 | 1.582 | 31 |

### Example 3

Production of compact discs.

The granular material produced in Examples 1 and 2 is processed into compact discs (diameter: 118 mm, thickness: 1.2 mm) on a Netstal Diskjet injection moulding machine at 320° C. bulk temperature and 60° C. tool temperature.

### Comparison Example

For purposes of comparison compact discs are produced from bisphenol A-PC (Makrolon CD 2005) under the conditions of Example 3.

The double refraction properties listed in Table 2 are measured on these compact discs at a radius of 35 mm.

TABLE 2

| | Δn(r, φ) | Δn(r, z) | Δn(r, φf) |
|---|---|---|---|
| Example: | (in plane) [nm] | (out of plane) [nm] | (out of plane) [nm] |
| 3 | −1.7 | 157 | 136 |
| Comparison | 32 | 643 | 513 |

1. Copolyester carbonate containing repeating, bifunctional structural units A derived from acids according to formula (I), 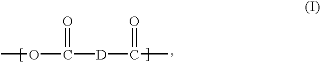
wherein
D denotes a mixture of divalent hydrocarbon radicals containing 30 to 42 carbon atoms, and D substantially corresponds to formula Ia and/or Ib and/or Ic and/or Id and/or Ie 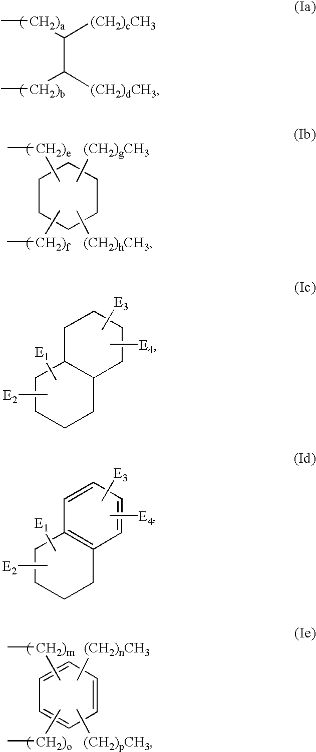
wherein
E₁, E₂, E₃ and E₄ in formula Ic and Id in each case denote one of the substituents —(CH₂)ᵢ—, —(CH₂)ⱼ—, —(CH₂)ₖCH₃ and —(CH₂)₁CH₃, and a, b, c, d, e, f, g, h, i, j, k, l, m, n, o and p independently of one another denote an integer between 1 and 10.

2. Copolyester carbonate according to claim 1, characterised in that the educts used for the bifunctional structural elements A have an iodine number of less than about 15.

3. Copolyester carbonate according to claim 1, characterised in that the educts used for the bifunctional structural elements A have less than about 1.5% of fractions with functionalities greater than 2.

4. Copolyester carbonate according to one of claims 1 to 3, characterised in that the glass transition temperature is about 120° C. to 185° C.

5. Copolyester carbonate according to one of claims 1 to 4, characterised in that the water uptake at saturation is less than about 0.35%.

6. Copolyester carbonate according to one of claims 1 to 5, characterised in that the polyester carbonate contains at least one of the further bifunctional structural units B, different from A, according to formula (II) 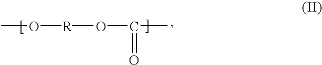
wherein the radical —O—R—O— denotes arbitrary diphenolate radicals in which —R— is an aromatic radical with 6 to 40 C atoms that may contain one or more aromatic or condensed aromatic nuclei optionally containing heteroatoms and is optionally substituted with C₁ to C₁₂-alkyl radicals or halogen, and may contain aliphatic radicals, cycloaliphatic radicals, aromatic nuclei or heteroatoms as bridge members.

7. Copolyester carbonate according to claim 6, characterised in that the bifunctional carbonate structural units of the formula (II) as homopolycarbonate have a glass transition temperature of greater than about 170° C.

8. Copolyester carbonate according to claim 6, characterised in that at least one of the bifunctional carbonate structural units B of the formula (II) is derived from 1,1-bis-(4-hydroxyphenyl)-3,3,5-trimethylcyclohexane.

9. Copolyester carbonate according to claim 6, characterised in that at least one of the bifunctional carbonate structural units B of the formula (II) is derived from 2,2-bis-(4-hydroxyphenyl)-propane.

10. Copolyester carbonate according to claim 6, characterised in that at least one of the bifunctional carbonate structural units B of the formula (II) is derived from 6,6′-dihydroxy-3,3,3′,3′-tetramethyl-1,1′-spiro(bis)-indane or 1,1-bis-(3-methyl-4-hydroxyphenyl)-cyclohexane or 1-(p-hydroxyphenyl)-1,3,3-trimethyl-5-indanol.

11. Copolyester carbonate according to one of claims 6 to 10, characterised in that it contains 0.5 to 49 mole % of bifunctional structural units A, referred to 100 mole % of the bifunctional structural units A and B.

12. Copolyester carbonate according to one of claims 1 to 11, characterised in that the mean weight average molecular weight M_{w}, is 7,000 to 40,000.

13. Copolyester carbonate according to one of claims 1 to 12, characterised in that the glass transition temperature is about 125° C. to 150° C. and that it contains 5-20 mole % of bifunctional structural units A, referred to 100 mole % of the bifunctional structural units A and B, and that the weight average molecular weight M_{w} is 9,000 to 30,000.

14. Moulded parts containing a copolyester carbonate according to one of claims 1 to 13, in particular optical lenses, sheets and films.

15. Machine-readable data carrier, characterised in that it is based on a substrate comprising a copolyester carbonate according to claims 1 to 13.
